(19) United States
(12) Patent Application Publication
(10) Pub. No.: US 2025/0203708 A1
(43) Pub. Date: Jun. 19, 2025

(54) METHODS AND APPARATUSES FOR DISABLING NEIGHBOR CELL MEASUREMENT TRIGGERING

(71) Applicant: Lenovo (Beijing) Limited, Beijing (CN)

(72) Inventors: Min Xu, Beijing (CN); Lianhai Wu, Beijing (CN); Jing Han, Beijing (CN); Ran Yue, Beijing (CN); Jie Hu, Beijing (CN)

(73) Assignee: Lenovo (Beijing) Limited, Beijing (CN)

(21) Appl. No.: 18/849,187

(22) PCT Filed: Mar. 24, 2022
(86) PCT No.: PCT/CN2022/082767

§ 371 Date: Sep. 20, 2024

(51) Int. Cl. H04W 76/28; H04B 17/318; H04W 56/00; H04W 76/30

(52) U.S. Cl. CPC H04W 76/28; H04B 17/328; H04W 56/0045; H04W 76/30

(57) ABSTRACT

The present application relates to methods and apparatuses for disabling a neighbour cell measurement triggering. One embodiment of the present disclosure provides a user equipment (UE) which includes: a transceiver; and a processor coupled with the transceiver, and the processor is configured to: determine at least one condition associated with network coverage; and determine whether to disable or enable a neighbour cell measurement triggering based on the at least one condition when the UE is in a connected mode.

### TECHNICAL FIELD

The present disclosure relates to non-terrestrial network (NTN), and more particularly, relates to methods and apparatuses for disabling a neighbour cell measurement triggering.

### BACKGROUND OF THE INVENTION

In mobile communication systems, such as long term evolution (LTE) and new radio (NR) networks, neighbour cell measurement in connected mode is performed by a user equipment (UE) to measure the signal strength or quality of neighbour cells, which can be used to assist mobility decisions e.g., handover. For regular users like smart phones in LTE and NR, neighbour cell measurement in connected mode is configured by network and the result can be reported by the UE via the measurement report. For a narrow band internet of things (NB-IoT) UE, which is sensitive to battery life and power consumption, neighbour cell measurement and reporting the same in connected mode are not supported until 3GPP Rel-17 for power saving, and the connected mobility is done by radio link failure (RLF) and radio resource control (RRC) re-establishment procedures.

In NTN, the network coverage may be discontinuous. Unlike the temporary coverage interruptions in terrestrial networks (TN), in NTN the coverage interruptions may last for a longer time duration (e.g., hours) and are predictable with the help of satellite assistance information. In the case that there may be no neighbour cell to measure, the neighbour cell measurement may still be triggered by a UE in connected mode.

Therefore, it would be desirable to provide solutions for disabling a neighbour cell measurement triggering under certain scenarios.

### SUMMARY

One embodiment of the present disclosure provides a UE which includes: a transceiver; and a processor coupled with the transceiver, and the processor is configured to: determine at least one condition associated with network coverage; and determine whether to disable or enable a neighbour cell measurement triggering based on the at least one condition when the UE is in a connected mode.

In some embodiments, the at least one condition is associated with receipt of an indication received from a base station (BS), and the indication includes at least one of the following: an indication of disabling the neighbour cell measurement; a system information block (SIB) dedicated for the network coverage; satellite assistance information for the network coverage; mean ephemeris data for the network coverage; or a release message for a configuration of a reference signal receiving power (RSRP) threshold and/or a RSRP variation threshold for the neighbour cell measurement triggering.

In some embodiments, the at least one condition includes at least one of the following parameters configured by the network: a prediction of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, the at least one condition includes at least one of the following parameters generated by the UE: a prediction of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, disabling a neighbour cell measurement triggering includes at least one of the following operation: disabling a RSRP measurement of a serving cell; stopping evaluating a RSRP and/or RSRP variation criteria for the neighbour cell measurement triggering; or forbidding the neighbour cell measurement triggering in response to the RSRP and RSRP variation criteria being fulfilled.

In some embodiments, in response to the neighbour cell measurement triggering being disabled, the processor is further configured to perform at least one of the following operation: discarding or storing a RSRP threshold and/or a RSRP variation threshold configured by network; stopping a timer for evaluating a RSRP variation criterion; discarding or storing a reference RSRP value for evaluating the RSRP variation criterion; transmitting a message indicating the neighbour cell measurement triggering is disabled; transmitting a message indicating fulfillment of the at least one condition associated with disabling the neighbour cell measurement triggering; or triggering a RLF or a RRC release.

In some embodiments, in response to the neighbour cell measurement triggering being enabled, wherein the processor is further configured to perform at least one of the following operation: requesting for a new RSRP threshold and/or a new RSRP variation threshold; using a stored RSRP threshold and a stored RSRP variation threshold as the new RSRP threshold and the new RSRP variation threshold; starting a timer for evaluating a RSRP variation criterion; determining a measured RSRP value or a stored reference RSRP value as a reference RSRP value for evaluating the RSRP variation criterion; transmitting a message indicating that the neighbour cell measurement triggering is enabled; transmitting a message indicating fulfillment of the at least one condition associated with enabling the neighbour cell measurement triggering; or prioritizing a carrier for the neighbour cell measurement indicated by the network.

Another embodiment of the present disclosure provides a Base Station (BS) which includes: a transceiver; and a processor coupled with the transceiver, and the processor is further configured to: determine at least one condition associated with network coverage; and transmit the at least one condition to a UE for determining whether the neighbour cell measurement triggering will be disabled or enabled when the UE is in a connected mode.

In some embodiments, the at least one condition is associated with a message transmitted to the UE, wherein the message includes at least one of the following: an indication of disabling the neighbour cell measurement; an SIB dedicated for the network coverage; satellite assistance information for the network coverage; mean ephemeris data for the network coverage; or a release message for a configuration of a RSRP threshold and/or a RSRP variation threshold for the neighbour cell measurement triggering.

In some embodiments, the at least one condition includes at least one of the following parameters determined by the BS: a predication of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, the at least one condition is associated with at least one of the following: an indication of disabling or enabling a RSRP measurement of a serving cell; an indication of stopping or starting evaluating a RSRP and RSRP variation criteria for the neighbour cell measurement triggering; an indication of forbidding or allowing the neighbour cell measurement triggering in response to the RSRP and RSRP variation criteria being fulfilled.

In some embodiments, the processor is further configured to: receive a message indicating the neighbour cell measurement triggering is disabled; receive a message indicating fulfillment of the at least one condition associated with disabling the neighbour cell measurement triggering; or receive a RLF report or a RRC release request.

In some embodiments, the processor is further configured to: receive a request for a new RSRP threshold and/or a new RSRP variation threshold; receive a message indicating that the neighbour cell measurement triggering is enabled; receive a message indicating fulfillment of the at least one condition associated with enabling the neighbour cell measurement triggering.

In some embodiments, in response to the neighbour cell measurement triggering is enabled for the UE, the processor is further configured to transmit an indication indicating the UE to prioritize a carrier for the neighbour cell measurement.

Yet another embodiment of the present disclosure provides a method performed by a UE which includes: determining at least one condition associated with network coverage; and determining whether to disable or enable a neighbour cell measurement triggering based on the at least one condition when the UE is in a connected mode.

In some embodiments, the at least one condition is associated with receipt of an indication received from a BS, and the indication includes at least one of the following: an indication of disabling the neighbour cell measurement; an SIB dedicated for the network coverage; satellite assistance information for the network coverage; mean ephemeris data for the network coverage; or a release message for a configuration of a RSRP threshold and/or a RSRP variation threshold for the neighbour cell measurement triggering.

In some embodiments, the at least one condition includes at least one of the following parameters configured by the network: a prediction of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, the at least one condition includes at least one of the following parameters generated by the UE: a prediction of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, disabling a neighbour cell measurement triggering includes at least one of the following operation: disabling a RSRP measurement of a serving cell; stopping evaluating a RSRP and/or RSRP variation criteria for the neighbour cell measurement triggering; or forbidding the neighbour cell measurement triggering in response to the RSRP and RSRP variation criteria being fulfilled.

In some embodiments, in response to the neighbour cell measurement triggering being disabled, the method further comprising: performing at least one of the following operation: discarding or storing a RSRP threshold and/or a RSRP variation threshold configured by network; stopping a timer for evaluating a RSRP variation criterion; discarding or storing a reference RSRP value for evaluating the RSRP variation criterion; transmitting a message indicating the neighbour cell measurement triggering is disabled; transmitting a message indicating fulfillment of the at least one condition associated with disabling the neighbour cell measurement triggering; or triggering a RLF or a RRC release.

In some embodiments, in response to the neighbour cell measurement triggering being enabled, the method further comprising performing at least one of the following operation: requesting for a new RSRP threshold and/or a new RSRP variation threshold; using a stored RSRP threshold and a stored RSRP variation threshold as the new RSRP threshold and the new RSRP variation threshold; starting a timer for evaluating a RSRP variation criterion; determining a measured RSRP value or a stored reference RSRP value as a reference RSRP value for evaluating the RSRP variation criterion; transmitting a message indicating that the neighbour cell measurement triggering is enabled; transmitting a message indicating fulfillment of the at least one condition associated with enabling the neighbour cell measurement triggering; or prioritizing a carrier for the neighbour cell measurement indicated by the network.

Still another embodiment of the present disclosure provides a method performed by a Base Station (BS), which includes: determining at least one condition associated with network coverage; and transmitting the at least one condition to a UE for determining whether the neighbour cell measurement triggering will be disabled or enabled when the UE is in a connected mode.

In some embodiments, the at least one condition is associated with a message transmitted to the UE, wherein the message includes at least one of the following: an indication of disabling the neighbour cell measurement; an SIB dedicated for the network coverage; satellite assistance information for the network coverage; mean ephemeris data for the network coverage; or a release message for a configuration of a RSRP threshold and/or a RSRP variation threshold for the neighbour cell measurement triggering.

In some embodiments, the at least one condition includes at least one of the following parameters determined by the BS: a predication of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, the at least one condition is associated with at least one of the following: an indication of disabling a RSRP measurement of a serving cell; an indication of stopping evaluating a RSRP and RSRP variation criteria for the neighbour cell measurement triggering; an indication of forbidding the neighbour cell measurement triggering in response to the RSRP and RSRP variation criteria being fulfilled.

In some embodiments, the method further includes receiving a message indicating the neighbour cell measurement triggering is disabled; receiving a message indicating fulfillment of the at least one condition associated with disabling the neighbour cell measurement triggering; or receiving a RLF report or a RRC release request.

In some embodiments, the method further includes receiving a request a new RSRP threshold and/or a new RSRP variation threshold; receiving a message indicating that the neighbour cell measurement triggering is enabled; receiving a message indicating fulfillment of the at least one condition associated with enabling the neighbour cell measurement triggering.

In some embodiments, in response to the neighbour cell measurement triggering is enabled for the UE, further comprising transmitting an indication indicating the UE to prioritize a carrier for the neighbour cell measurement.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure.

FIG. 2 illustrates an exemplary flow chart of disabling or enabling a neighbour cell measurement triggering according to some embodiments of the present disclosure.

FIG. 3 illustrates an exemplary flow chart of disabling or enabling a neighbour cell measurement triggering according to some embodiments of the present disclosure.

FIG. 4 illustrates a method performed by a UE for wireless communication according to a preferred embodiment of the present disclosure.

FIG. 5 illustrates a method performed by a BS for wireless communication according to a preferred embodiment of the present disclosure.

FIG. 6 illustrates an exemplary simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

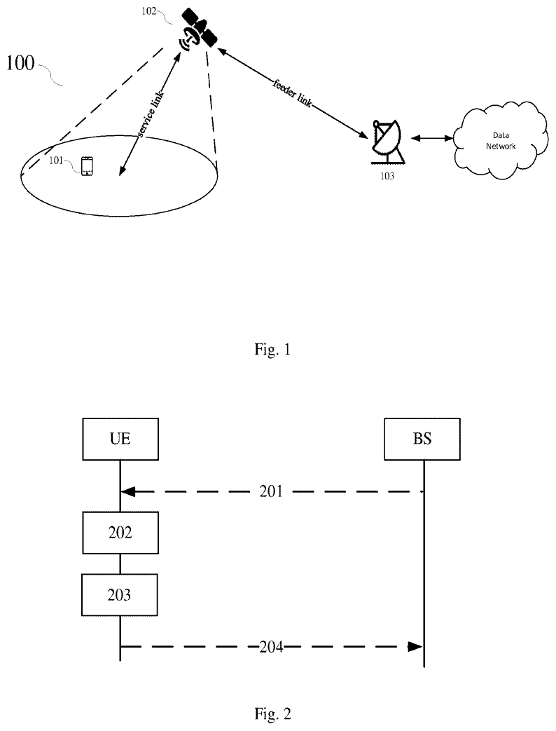

FIG. 1 depicts an exemplary NTN network in which techniques disclosed herein may be implemented, in accordance with some embodiments of the present disclosure.

The NTN network refers to networks, or segments of networks, using an airborne or space-borne vehicle to embark an NTN payload. The NTN payload performs the desired communication function of the satellite (e.g., high altitude platform station (HAPS)) between the service and the feeder link. It is embarked on board space/airborne vehicle. The HAPS refers to airborne vehicle embarking the NTN payload placed at an altitude between 8 and 50 km.

As shown in FIG. 1, the NTN network 100 includes at least one UE 101 and at least one satellite BS 102, or alternatively a UAS platform 102. Although only one UE 101 and a satellite/UAS platform 102 are depicted in FIG. 1, it is contemplated that any number of UEs 101 and satellites/UAS platforms 102 may be included in the wireless communication system 100.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, user terminals, a device, or by other terminology used in the art. The UE 101 may communicate directly with the satellite BS 102 via service link.

Satellite(s) BS 102 may include low earth orbiting (LEO) satellites orbiting around the Earth, medium earth orbiting (MEO) satellites, geostationary earth orbiting (GEO) satellites with fixed location to the Earth, as well as highly elliptical orbiting (HEO) satellites. UAS platform(s) 102 may include unmanned aircraft systems (UAS) including tethered UAS and lighter than air UAS (LTA), heavier than air UAS (HTA), and high altitude platforms UAS (HAPs). For convenience, we will use satellite 102 hereinafter to elaborate the present disclosure. However, persons skilled in the art can know that the same technique may also be applied to UAS platform(s).

Satellite(s) BS 102 may further include microsatellite platforms (e.g., cube satellites) with limited size and power and low-density satellite constellations, which have restricted link budget and discontinuous coverage. UEs served by the microsatellite platforms may remain long periods of time without being able to detect a satellite cell. The coverage discontinuity is mainly caused by LEO satellite deployment and movement, and may be UE-specific relating to UE location, UE requested slices or UE subscriptions to networks. The coverage discontinuity may also be referred to as coverage interruption, or coverage edge, or the like. The coverage continuity, on the other hand, may suggest no coverage discontinuity. Either “coverage discontinuity” or “coverage continuity” mentioned above may refer to network coverage hereinafter.

Referring to FIG. 1, the satellite 102 provides a geographic cell for serving UE 101 located in the geographic cell. In FIG. 1, example UE may be a normal mobile terminal 101, which can wirelessly communicate with the satellite/UAS platform 102 via a communications link, such as service link or radio link in accordance with a NR access technology (e.g., a NR-Uu interface). As also shown in FIG. 1, the satellite 102 also communicates with a gateway 103 or earth station via a communication link, which may be a feeder link or radio link in accordance with NR access technologies or other technologies. In accordance with various embodiments, the satellite 102 may be implemented with either a transparent or a regenerative payload. When the satellite carries a “transparent” payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (re, all or part of base station functions (e.g., a gNB, eNB, etc.) are implemented on board.

A typical terrestrial communication network includes one or more base stations (typically known as a “BS”) that are located on earth (i.e., not airborne or spaceborne) that each provides geographical radio coverage, and UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

Returning back to FIG. 1, the gateway 103 may be coupled to a data network such as, for example, the Internet, terrestrial public switched telephone network, mobile telephone network, or a private server network, etc. Gateway 103 and the satellite 102 communicate over a feeder link, which has both a feeder uplink from the gateway 103 to the satellite 102 and a feeder downlink from the satellite 102 to the gateway 103. Although a single gateway 103 is shown, some implementations will include many gateways, such as five, ten, or more. One embodiment includes only one gateway. UE 101 and satellite 102 communicate over service link, which has both an uplink from the UE 101 to the BS 102 and a downlink from the BS 102 to the UE 101.

In some embodiments, communication within the system of FIG. 1 follows a nominal roundtrip direction whereby data is received by gateway from data network (e.g., the Internet) and transmitted over a forward path to a set of UE 101. In one example, communication over the forward path comprises transmitting the data from gateway to satellite 102 via uplink of the feeder link, through a first signal path on satellite, and from satellite 102 to UE(s) 101 via downlink of the service link. Data can also be sent from the UEs 101 over a return path to gateway. In one example, communication over the return path comprises transmitting the data from a UE (e.g., UE101a) to satellite 102 via uplink of the service link, through a second signal path on satellite 102, and from satellite 102 to gateway via downlink of the feeder link.

The wireless communication system 100 is compliant with any type of network that is capable of sending and receiving wireless communication signals. For example, the wireless communication system 100 is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3rd generation partnership project (3GPP)-based network, 3GPP 5G network, a satellite communications network, a high altitude platform network, and/or other communications networks.

In one implementation, the wireless communication system 100 is compliant with the NR of the 3GPP protocol, wherein the BS 102 transmits using an OFD modulation scheme on the DL and the UE 101 transmits on the UL using a single-carrier frequency division multiple access (SC-FDMA) scheme or OFDM scheme. More generally, however, the wireless communication system 100 may implement some other open or proprietary communication protocol, for example, WiMAX, among other protocols.

In other embodiments, the BS 102 may communicate using other communication protocols, such as the IEEE 802.11 family of wireless communication protocols. Further, in some embodiments the BS 102 may communicate over licensed spectrum, while in other embodiments the BS 102 may communicate over unlicensed spectrum. The present disclosure is not intended to be limited to the implementation of any particular wireless communication system architecture or protocol. In another embodiment, the BS 102 may communicate with the UE 101 using the 3GPP 5G protocols.

In some scenarios, the microsatellite platforms, i.e., the cube satellites, with limited size and power and low-density constellations, which have restricted link budget and discontinuous service link coverage where UE devices may remain long periods of time without being able to detect a satellite cell.

For NTN, the discontinuous coverage may happen in space and/or time domain due to sparse constellation of satellites, the movement of the satellite, and the movement of the UE.

For instance, in FIG. 1, the UE 101 may not be able to detect the satellite cell of the satellite 102 when the satellite 102 moves to other locations, and the UE 101 may detect the satellite cell of the satellite 102 when the satellite 102 moves back. That is, the coverage is discontinuous in time domain. In other scenarios, the UE 101 may move outside the coverage of the satellite 102, and the service link is discontinuous in space domain. In other words, the service coverage of the BS is variable. The variable coverage may happen in the following scenarios: an early stage 5G network, a private network, a network providing coverage with moving BSs or relays, a BS located on a hot balloon, a BS located on a drone, etc.

In mobile communication systems including LTE and NR networks, neighbour cell measurement in connected mode may be performed by a UE in connected mode, to measure the signal strength or quality of neighbour cells, which may be used to assist mobility decisions i.e., handover. For regular users like smart phones in LTE and NR, neighbour cell measurement in connected mode is configured by network and the result may be reported by a UE via measurement report.

Before 3GPP Rel-17, for a narrow band internet of things (NB-IoT) UE, which is sensitive to battery life and power consumption, neighbour cell measurement and report in connected mode are not supported. The connected mobility is done by RLF and RRC re-establishment procedures. Specifically, when a NB-IoT UE moves to a neighbour cell, RLF is declared when radio link problem is detected and the timer T310 expires. The NB-IoT UE then enters into the idle mode to perform cell selection to select a neighbour cell and initiates a RRC re-establishment procedure. In conclusion, it takes a much longer time for the NB-IoT UE to re-connect to the network compared with other UEs, such as LTE UEs or NR UEs.

It is observed that, if the NB-IoT UE can measure the neighbour cell before triggering RLF, the time of cell selection between RLF declaration and RRC re-establishment may be shorten.

The criteria of triggering neighbour cell measurement in connected mode for NB-IoT UE may include a combination of serving cell RSRP and the RSRP variance. More specifically, if the measured serving cell RSRP is lower than one threshold and the RSRP variance compared to a reference RSRP is higher than another threshold, the NB-IoT UE may perform neighbour cell measurements.

However, in NTN, the discontinuous coverage may happen in space and/or time domain due to sparse constellation of satellites, the movement of the satellite, and the movement of the UE. Unlike the temporary coverage interruptions in TN, in NTN the coverage interruptions may last for a longer time duration (e.g., hours) and are predictable with the help of satellite assistance information.

When the network coverage is to become discontinuous, a NB-IoT UE in the connected mode may still perform the neighbour cell measurement, which is unnecessary. This unnecessary neighbour cell measurement may lead to additional and unnecessary power consumption which is at least essential to the NB-IoT UEs.

The present disclosure proposes several solutions for solving the above issue. It should be noted that the solutions not only apply to NB-IoT UEs, but also apply to other UEs, such as LTE UE, NR UEs, etc., and hereinafter the term “UE” is used for short.

FIG. 2 illustrates an exemplary flow chart of disabling or enabling a neighbour cell measurement triggering according to some embodiments of the present disclosure.

In operation 201, the UE may receive an indication from the BS. It should be noted that operation 201 is optional, in some solutions of the present disclosure, the BS may transmit the indication to the UE, while in other solutions, the BS may not transmit the indication to the UE. The indications may include indications A1-A5 described below:

Indication A1: an explicit indication of disabling the neighbour cell measurement triggering or enabling the neighbour cell measurement triggering.

Indication A2: a system information block (SIB) dedicated for network coverage. The network coverage may include the coverage discontinuity, which may suggest that there is no neighbour cell to be measured by the UE. The network coverage may also include coverage continuity, which may suggest that the serving cell may still be on service for a period of time, or there is at least one neighbour cell to be measured by the UE. That is, the SIB may indicate coverage discontinuity of the serving cell, or indicate coverage continuity of the cells (including the serving cell and at least one neighbour cell). The SIB may be considered as an implicit indication of disabling the neighbour cell measurement triggering or enabling the neighbour cell measurement triggering.

Indication A3: satellite assistance information for network coverage. The satellite assistance information may indicate coverage discontinuity of the serving cell, or indicate coverage continuity of the cells. The satellite assistance information may be considered as an implicit indication of disabling the neighbour cell measurement triggering or enabling the neighbour cell measurement triggering.

Indication A4: mean ephemeris data for network coverage. The mean ephemeris data may indicate coverage discontinuity of the serving cell, or indicate coverage continuity of the cells. The mean ephemeris data may be considered as an implicit indication of disabling the neighbour cell measurement triggering or enabling the neighbour cell measurement triggering.

Indication A5: a release message for the configuration of RSRP threshold and/or RSRP variation threshold for measurement triggering. The release message may be considered as an implicit indication of disabling the neighbour cell measurement triggering or enabling the neighbour cell measurement triggering.

In some other embodiments, in operation 201, the BS may transmit at least one the following parameters B1-B6 configured by the BS or by the network to the UE:
Parameter B1: a prediction of network coverage or an updated prediction of network coverage;
Parameter B2: a time point, which may include at least one of: a stop serving time of a cell, a remaining serving time of the cell, a threshold associated with the stop serving time, or a threshold associated with remaining serving time, etc.;
Parameter B3: a location, which may include at least one of: a reference location, a footprint edge of a cell, a threshold associated with the reference location, a threshold associated with the footprint edge of a cell, etc.;
Parameter B4: an area, which may include a boundary area of a cell;
Parameter B5: a threshold of propagation delay; or
Parameter B6: a threshold of timing advance.

In operation 202, the UE may determine at least one condition associated with network coverage.

In the case that the BS transmit the indication to the UE, i.e., operation 201 is performed, the UE may determine the at least one condition associated with network coverage based on the indication received from the BS in operation 201.

In operation 203, the UE is in connected mode, and the UE may determine whether to disable the neighbour cell measurement triggering or enable the neighbour cell measurement triggering based on the at least one condition determined based on the indication received from the BS. Specifically, based on the different indications A1-A5, the BS may take the following options C1-C5:

Option C1: after receiving an explicit indication of disabling the neighbour cell measurement triggering or enabling the neighbour cell measurement triggering, the UE may disable the neighbour cell measurement triggering or enable the neighbour cell measurement triggering according to the explicit indication.

In some other embodiments, in the case that no explicit indication of disabling the neighbour cell measurement triggering is received, the UE may enable, or stay enabling the neighbour cell measurement triggering; and in the case that no explicit indication of enabling the neighbour cell measurement triggering is received, the UE may disable, or stay disabling the neighbour cell measurement triggering.

Option C2: after receiving the SIB dedicated for network coverage, the UE may consider the SIB as an implicit indication of disabling the neighbour cell measurement triggering or an implicit indication of enabling the neighbour cell measurement triggering. Specifically, if the SIB dedicated for network coverage indicates the coverage discontinuity, the UE may thus disable, or stay disabling the neighbour cell measurement triggering. If the SIB dedicated for network coverage indicates the coverage continuity, the UE may thus enable, or stay enabling the neighbour cell measurement triggering.

In some other embodiments, there may be two types of SIB dedicated for network coverage. The first type of SIB may be an SIB dedicated for coverage discontinuity, that is, the first type of SIB may indicate the coverage discontinuity, and when the first type of SIB is received, the UE may disable, or stay disabling the neighbour cell measurement triggering; in the case that no first type of SIB is received, the UE may enable, or stay enabling the neighbour cell measurement triggering.

The second type of SIB may be an SIB dedicated for coverage continuity, and when the second type of SIB is received, the UE may thus enable, or stay enabling the neighbour cell measurement triggering; in the case that no second type of SIB is received, the UE may disable, or stay disabling the neighbour cell measurement triggering.

Option C3: after receiving satellite assistance information for network coverage, the UE may consider the satellite assistance information for network coverage as an implicit indication of disabling the neighbour cell measurement triggering or an implicit indication of enabling the neighbour cell measurement triggering. Specifically, the satellite assistance information may indicate the coverage discontinuity, thus the UE may disable, or stay disabling the neighbour cell measurement triggering. The satellite assistance information may indicate the coverage continuity, thus the UE thus may enable, or stay enabling the neighbour cell measurement triggering.

In some other embodiments, there may be two types of satellite assistance information. The first type of satellite assistance information may be satellite assistance information dedicated for coverage discontinuity, that is, the first type of satellite assistance information may indicate the coverage discontinuity, and when the first type of satellite assistance information is received, the UE may disable, or stay disabling the neighbour cell measurement triggering; in the case that no first type of satellite assistance information is received, the UE may enable, or stay enabling the neighbour cell measurement triggering.

The second type of satellite assistance information may be satellite assistance information dedicated for coverage continuity, and when the second type of satellite assistance information is received, the UE may thus enable, or stay enabling the neighbour cell measurement triggering; in the case that no second type of satellite assistance information is received, the UE may disable, or stay disabling the neighbour cell measurement triggering.

Option C4: after receiving mean ephemeris data for network coverage, the UE may consider the mean ephemeris data for network coverage as an implicit indication of disabling the neighbour cell measurement triggering or an implicit indication of enabling the neighbour cell measurement triggering. Specifically, the mean ephemeris data may indicate the coverage discontinuity, thus the UE may disable, or stay disabling the neighbour cell measurement triggering. The mean ephemeris data may indicate the coverage continuity, thus the UE may enable, or stay enabling the neighbour cell measurement triggering.

In some other embodiments, in the case that no mean ephemeris data indicating the coverage discontinuity is received, the UE may enable, or stay enabling the neighbour cell measurement triggering; and in the case that no mean ephemeris data indicating the coverage continuity is received, the UE may disable, or stay disabling the neighbour cell measurement triggering.

In some other embodiments, there may be two types of mean ephemeris data. The first type of mean ephemeris data may be mean ephemeris data dedicated for coverage discontinuity, that is, the first type of mean ephemeris data may indicate the coverage discontinuity, and when the first type of mean ephemeris data is received, the UE may disable, or stay disabling the neighbour cell measurement triggering; in the case that no first type of mean ephemeris data is received, the UE may enable, or stay enabling the neighbour cell measurement triggering.

The second type of mean ephemeris data may be mean ephemeris data dedicated for coverage continuity, and when the second type of mean ephemeris data is received, the UE may thus enable, or stay enabling the neighbour cell measurement triggering; in the case that no second type of mean ephemeris data is received, the UE may disable, or stay disabling the neighbour cell measurement triggering.

Option C5: after receiving a release message for the configuration of RSRP threshold and/or RSRP variation threshold for measurement triggering, the UE may consider the release message as an implicit indication of disabling the neighbour cell measurement triggering. In the case that the UE does not receive the release message, the UE may consider it implicitly indicates the UE to enable to neighbour cell measurement triggering, thus the UE may enable, or stay enabling the neighbour cell measurement triggering; and in the case that the UE receives the release message, the UE may consider it implicitly indicates the UE to disable neighbour cell measurement triggering, thus the UE may disable, or stay disabling the neighbour cell measurement triggering

In operation 203, the UE may perform the determination based on the at least one condition determined according to the parameters (i.e., parameters B1-B6) received from the BS with the following options D1-D6:

Option D1: after receiving a prediction of network coverage, the UE may determine whether the prediction of network coverage indicates the coverage discontinuity or coverage continuity. In the case that the prediction of network coverage indicates the coverage discontinuity, the UE may thus disable, or stay disabling the neighbour cell measurement triggering. In the case that the prediction of network coverage indicates coverage continuity, the UE may thus enable, or stay enabling the neighbour cell measurement triggering.

Option D2: after receiving the time point, the UE may determine whether the current time approaches a time point. The UE may compare the current time with the time point, and in the case that the time difference is lower than or equal to a time threshold, the UE may determine that the current time approaches the time point, and the UE may disable, or stay disabling the neighbour cell measurement triggering. In the case that the time difference is higher than the time threshold, the UE may determine that the current time does not approach the time point, and the UE may enable, or stay enabling the neighbour cell measurement triggering.

Option D3: after receiving the location, the UE may determine whether the current location of the UE approaches a location. The UE may compare the current location with the received location, and in the case that the distance is lower than or equal to a distance threshold, the UE may determine that the current location of the UE approaches the received location, and the UE may disable, or stay disabling the neighbour cell measurement triggering In the case that the distance is higher than the distance threshold, the UE may determine that the current location of the UE does not approach the received location, and the UE may enable, or stay enabling the neighbour cell measurement triggering.

Option D4: after receiving an area, the UE may determine whether the current location of the UE is within the area. In the case that the current location of the UE is within the area, the UE may disable, or stay disabling the neighbour cell measurement triggering; in the case that the UE is not within the area; the UE may enable, or stay enabling the neighbour cell measurement triggering.

Option D5: after receiving the threshold of propagation delay, the UE may determine whether the propagation delay of the UE is lower or higher than a propagation delay threshold. In the case that the measured propagation delay of the UE is higher than the propagation delay threshold, the UE may disable, or stay disabling the neighbour cell measurement triggering; in the case that the measured propagation delay of the UE is lower than or equal to the propagation delay threshold; the UE may enable, or stay enabling the neighbour cell measurement triggering.

Option D6: after receiving the threshold of timing advance, the UE may determine whether the timing advance of the UE is lower or higher than a timing advance threshold. In the case that the measured timing advance of the UE is higher than the timing advance threshold, the UE may disable, or stay disabling the neighbour cell measurement triggering; in the case that the measured timing advance of the UE is lower than or equal to the timing advance threshold; the UE may enable, or stay enabling the neighbour cell measurement triggering.

The above parameters, such as the time information (i.e., the time point), the geographic information (i.e., the reference location, the area), and the propagation delay of the UE or the maintained timing advance of the UE may be derived from the available prediction or an updated prediction of coverage discontinuity determined by the BS.

In the case that the BS does not transmit the indication to the UE, i.e., operation 201 is not performed, the UE may determine at least one condition associated with network coverage by the UE itself. That is, the UE may determine the above parameters B1-B6 by the UE itself.

In operation 203, the UE may determine whether to disable or enable a neighbour cell measurement triggering based on the at least one condition when the UE is in a connected mode.

Specifically, the UE may perform the determination in a similar fashion as described in D1-D6, the difference is that the parameters (i.e., the prediction of network coverage, the time point, the location, the area, the threshold of propagation delay, and the threshold of timing advance) are not received from the BS, rather, they are determined by the UE. In some embodiments, the parameters such as the time point, the location, the area, the threshold of propagation delay, and the threshold of timing advance may be determined based on the prediction of network coverage or the updated prediction of network coverage.

In the present disclosure, disabling the neighbour cell measurement triggering may include at least one of the following disabling options:
Option E1: disabling the RSRP measurement of the serving cell;
Option E2: stopping evaluating the RSRP and/or RSRP variation criteria for the neighbour cell measurement triggering;
Option E3: forbidding the neighbour cell measurement triggering when the RSRP and/or RSRP variation criteria is fulfilled.

It should be noted that for options E2 and E3, the UE may still perform the RSRP measurement of the serving cell for other purposes.

Correspondingly, enabling the neighbour cell measurement triggering may include at least one of the following enabling options:
Option F1: enabling the RSRP measurement of the serving cell;
Option F2: starting evaluating the RSRP and/or RSRP variation criteria for the neighbour cell measurement triggering, the UE may determine the reference RSRP for the evaluation;
Option F3: allowing the neighbour cell measurement triggering when the RSRP and/or RSRP variation criteria is fulfilled.

It should be noted that the above disabling options E1-E3 or the enabling options F1-F3 may also be indicated by the network. For example, the BS may transmit an indication indicating the UE to disable the RSRP measurement of the serving cell (i.e., option E1). Alternatively, the above disabling options E1-E3 or the enabling options F1-F3 may be determined by UE implementation. For example, the BS may indicate to the UE to disable neighbour cell measurement triggering, and the UE may determine to forbid the neighbour cell measurement triggering when the RSRP and/or RSRP variation criteria is fulfilled (i.e., option E3).

In operation 204, the UE may transmit a message to the BS, indicating that the UE has disabled the neighbour cell measurement triggering, or has enabled the neighbour cell measurement triggering.

In the case that the UE has disabled the neighbour cell measurement triggering, the UE may transmit a message to the BS, reporting the disabling of the neighbour cell measurement triggering. The UE may also indicate the fulfillment of the at least one condition associated with disabling the neighbour cell measurement triggering, for example, the UE may indicate that the disabling is performed based on the explicit indication of disabling the neighbour cell measurement triggering as described in option C1 in the operation 203.

In the case that the UE has enabled the neighbour cell measurement triggering, the UE may transmit a message to the BS, reporting the enabling the neighbour cell measurement triggering. The UE may also indicate the fulfillment of the at least one condition associated with enabling the neighbour cell measurement triggering, for example, the UE may indicate that the enabling is performed based on an implicit indication such as an SIB dedicated for coverage continuity as described in option C2 in the operation 203.

It should be noted that operation 204 is optional, and in some embodiments, the UE may not transmit the message to the BS.

The UE may take further operations after disabling or enabling the neighbour cell measurement triggering. For example, in the case that the UE disables the neighbour cell measurement triggering, the UE may take at least one of the following operations:

Operation G1: the UE may discard the RSRP threshold and/or the RSRP variation threshold configured by network; alternatively, the UE may store the RSRP threshold and/or the RSRP variation threshold configured by network.

Operation G2: the UE may stop the timer for evaluating the RSRP and/or RSRP variation criterion in the case that the time for evaluating the RSRP variation criterion is running at the time when the UE disables the neighbour cell measurement triggering.

Operation G3: the UE may discard the reference RSRP value for evaluating the RSRP variation criterion; alternatively, the UE may store the reference RSRP value for evaluating the RSRP variation criterion.

Operation G4: the UE may trigger the RLF or the RRC release. For example, in the case that the UE has disabled the neighbour cell measurement triggering, when the UE determines that the coverage discontinuity may happen, the UE may trigger RLF or RRC release to allow UE to enter into IDLE mode.

In the case that the UE enables the neighbour cell measurement triggering, the UE may take at least one of the following operations:

Operation H1: in the case that the RSRP threshold and/or the RSRP variation threshold is discarded when the UE disabled the neighbour cell measurement triggering, the UE may request a new RSRP threshold and/or the RSRP variation threshold. In the case that the RSRP threshold and/or the RSRP variation threshold is stored when the UE disabled the neighbour cell measurement triggering, the UE may reuse the stored RSRP threshold and/or the RSRP variation threshold; or request a new RSRP threshold and/or the RSRP variation threshold.

Operation H2: the UE may start or restart the timer for evaluating the RSRP variation criterion.

Operation H3: in the case that the reference RSRP is discarded when the UE disables the neighbour cell measurement triggering, the UE may determine the first measured RSRP after enabling the neighbour cell measurement triggering as the reference RSRP for evaluating the RSRP variation criterion. In the case that the reference RSRP is stored when the UE disables the neighbour cell measurement triggering; the UE may reuse the stored reference RSRP, or use the first measured RSRP.

Operation H4: the UE may prioritize or deprioritize certain carriers or frequency bands for the neighbour cell measurement indicated by the network.

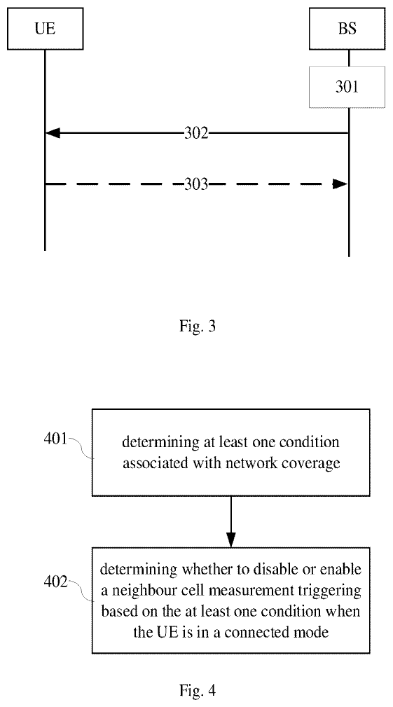

FIG. 3 illustrates an exemplary flow chart performed by a BS according to some embodiments of the present disclosure. The UE may disable or enable a neighbour cell measurement triggering accordingly.

In operation 301, the BS may determine at least one condition associated with network coverage. The BS may determine the abovementioned indications A1-A5 and/or parameters B1-B6, and these indications and/or parameters will be used to determine the conditions for disabling or enabling a neighbour cell measurement triggering.

For indication A1, i.e., an explicit indication of disabling the neighbour cell measurement triggering or enabling the neighbour cell measurement triggering, it may be determined based on a prediction of network coverage by the BS or the network, which indicates whether a UE is in network coverage or not in a time period and/or at a location. In the case that the UE is in network coverage in the time period at a location, the BS may determine indication A1 with the following options J1-J5:

Option J1: the BS may determine whether the current time approaches a time point. The time point is similar to the time point described in the above parameter B2. The BS may compare the current time with the time point, and in the case that the time difference is lower than or equal to a time threshold, the BS may determine that the current time approaches the time point, and the BS may transmit the explicit indication A1 to indicate the UE to disable, or stay disabling the neighbour cell measurement triggering. In the case that the time difference is higher than a time threshold, the BS may determine that the current time does not approach the time point, and the BS may transmit the explicit indication A1 to indicate the UE to enable, or stay enabling the neighbour cell measurement triggering.

Option J2: the BS may determine whether the current location of the UE approaches a reference location. The location is similar to the location described in the above parameter B3.

The BS may compare the current location with the reference location, and in the case that the distance is lower than or equal to a distance threshold, the BS may determine that the current location of the UE approaches the reference location, and the BS may transmit the explicit indication A1 to indicate the UE to disable, or stay disabling the neighbour cell measurement triggering In the case that the distance is higher than a distance threshold, the BS may determine that the current location of the UE does not approach the reference location, and the BS may transmit the explicit indication A1 to indicate the UE to enable, or stay enabling the neighbour cell measurement triggering.

Option J3: the BS may determine whether the current location of the UE is within an area. The area is similar to the area described in the above parameter B4.

The BS may compare the current location with the area, and in the case that the current location is within the area, the BS may transmit the explicit indication A1 to indicate the UE to disable, or stay disabling the neighbour cell measurement triggering. In the case that the current location is not within the area, the BS may transmit the explicit indication A1 to indicate the UE to enable, or stay enabling the neighbour cell measurement triggering.

Option J4: the BS may determine whether the propagation delay of the UE is higher or lower than a propagation delay threshold. The propagation delay is similar to the propagation delay described in the above parameter B5.

The BS may compare the propagation delay of the UE with a threshold, and in the case that the propagation delay is higher than the propagation delay threshold, the BS may transmit the explicit indication A1 to indicate the UE to disable, or stay disabling the neighbour cell measurement triggering. In the case that the propagation delay is equal to or lower than the propagation delay threshold, the BS may transmit the explicit indication A1 to indicate the UE to enable, or stay enabling the neighbour cell measurement triggering.

Option J5: the BS may determine whether the timing advance of the UE is higher or lower than a timing advance threshold. The timing advance is similar to the timing advance described in the above parameter B6.

The BS may compare the timing advance of the UE with a threshold, and in the case that the timing advance is higher than the timing advance threshold, the BS may transmit the explicit indication A1 to indicate the UE to disable, or stay disabling the neighbour cell measurement triggering. In the case that the timing advance is equal to or lower than the timing advance threshold, the BS may transmit the explicit indication A1 to indicate the UE to enable, or stay enabling the neighbour cell measurement triggering.

It should be noted that the above parameters, i.e., a time point, a location, an area, a threshold of propagation delay, and a threshold of timing advance may be derived from the predication of network coverage or updated predication of network coverage determined by the BS, or may be configured by the BS or by the network.

In operation 302, the BS may transmit the at least one condition to the UE.

In some embodiments, the BS may also determine the disabling options E1-E3 and the enabling options F1-F3, and transmit these options to the UE.

In operation 303, the BS may receive a message from the UE, indicating that the UE has disabled the RSRP measurement or has enabled the RSRP measurement. The BS may further receive the fulfillment of the at least one condition associated with disabling or enabling the neighbour cell measurement triggering.

In some embodiments, the BS may further transmit an indication to indicate certain carriers or frequency bands for the neighbour cell measurement for the UE to perform the neighbour cell measurement triggering, in the case that the UE has enabled neighbour cell measurement triggering, or the BS has transmit an indication indicating the UE to enable neighbour cell measurement triggering.

FIG. 4 illustrates a method performed by a UE for wireless communication according to a preferred embodiment of the present disclosure.

In operation 401, the UE may determine at least one condition associated with network coverage; and in operation 402, the UE may determine whether to disable or enable a neighbour cell measurement triggering based on the at least one condition when the UE is in a connected mode.

In some embodiments, the at least one condition is associated with receipt of an indication received from a BS, and the indication includes at least one of the following: an indication of disabling the neighbour cell measurement, e.g., indication A1; an SIB dedicated for the network coverage, e.g., indication A2; satellite assistance information for the network coverage, e.g., indication A3; mean ephemeris data for the network coverage, e.g., indication A4; or a release message for a configuration of a RSRP threshold and/or a RSRP variation threshold for the neighbour cell measurement triggering, e.g., indication A5.

In some embodiments, the at least one condition includes at least one of the following parameters configured by the network: a prediction of network coverage, e.g., parameter B1; a time point associated with the prediction of network coverage, e.g., parameter B2; an area associated with the prediction of network coverage, e.g., parameter B4; a location associated with the prediction of network coverage, e.g., parameter B3; a threshold of propagation delay associated with the prediction of network coverage, e.g., parameter B5; or a threshold of timing advance associated with the prediction of network coverage, e.g., parameter B6.

In some embodiments, the at least one condition includes at least one of the following parameters generated by the UE: a prediction of network coverage; a time point associated with the prediction of network coverage; an area associated with the prediction of network coverage; a location associated with the prediction of network coverage; a threshold of propagation delay associated with the prediction of network coverage; or a threshold of timing advance associated with the prediction of network coverage.

In some embodiments, disabling a neighbour cell measurement triggering includes at least one of the following operation: disabling a RSRP measurement of a serving cell, e.g., option E1; stopping evaluating a RSRP and/or RSRP variation criteria for the neighbour cell measurement triggering, e.g., option E2; or forbidding the neighbour cell measurement triggering in response to the RSRP and RSRP variation criteria being fulfilled, e.g., option E3.

In some embodiments, in response to the neighbour cell measurement triggering being disabled, the method further comprising: performing at least one of the following operation: discarding or storing a RSRP threshold and/or a RSRP variation threshold configured by network, e.g., operation G1; stopping a timer for evaluating a RSRP variation criterion, e.g., operation G2; discarding or storing a reference RSRP value for evaluating the RSRP variation criterion, e.g., operation G3; transmitting a message indicating the neighbour cell measurement triggering is disabled, e.g., operation 204 in FIG. 2; transmitting a message indicating fulfillment of the at least one condition associated with disabling the neighbour cell measurement triggering, e.g., operation 204 in FIG. 2; or triggering a RLF or a RRC release, e.g., operation G4.

In some embodiments, in response to the neighbour cell measurement triggering being enabled, the method further comprising performing at least one of the following operation: requesting for a new RSRP threshold and/or a new RSRP variation threshold, e.g., operation H1; using a stored RSRP threshold and a stored RSRP variation threshold as the new RSRP threshold and the new RSRP variation threshold, e.g., operation H1; starting a timer for evaluating a RSRP variation criterion, e.g., operation H2; determining a measured RSRP value or a stored reference RSRP value as a reference RSRP value for evaluating the RSRP variation criterion, e.g., operation H3; transmitting a message indicating that the neighbour cell measurement triggering is enabled, e.g., operation 204 in FIG. 2; transmitting a message indicating fulfillment of the at least one condition associated with enabling the neighbour cell measurement triggering, e.g., operation 204 in FIG. 2; or prioritizing a carrier for the neighbour cell measurement indicated by the network, e.g., operation H4.

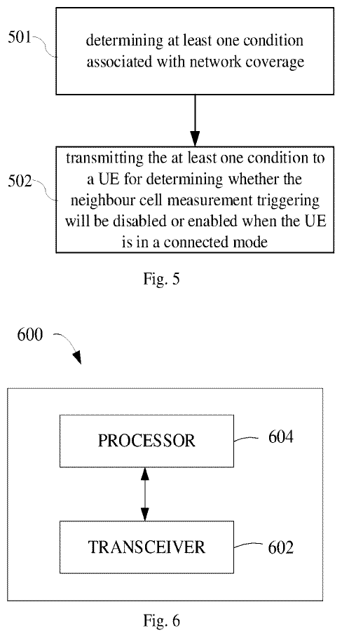

FIG. 5 illustrates a method performed by a BS for wireless communication according to a preferred embodiment of the present disclosure.

In operation 501, the BS may determine at least one condition associated with network coverage; and in operation 502, the BS may transmit the at least one condition to a UE for determining whether the neighbour cell measurement triggering will be disabled or enabled when the UE is in a connected mode.

FIG. 6 illustrates an exemplary simplified block diagram of an exemplary apparatus according to some embodiments of the present disclosure. As shown in FIG. 6, the apparatus 600 may include at least one processor 604 and at least one transceiver 602 coupled to the processor 604. The apparatus 600 may be a UE or a BS.

Although in this figure, elements such as the at least one transceiver 602 and processor 604 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 604 may interact with each other so as to perform the operations with respect to the UE described in FIGS. 1-5. In some embodiments of the present disclosure, the apparatus 600 may be a BS. The transceiver 602 and the processor 604 may interact with each other so as to perform the operations with respect to the BS described in FIGS. 1-5.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 604 to implement the method with respect to the UE as described above. For example, the computer-executable instructions, when executed, cause the processor 604 interacting with transceiver 602 to perform the operations with respect to the UE described in FIGS. 1-5.

In some embodiments of the present disclosure, the non-transitory computer-readable medium may have stored thereon computer-executable instructions to cause the processor 604 to implement the method with respect to the BS as described above. For example, the computer-executable instructions, when executed, cause the processor 604 interacting with transceiver 602 to perform the operations with respect to the BS described in FIGS. 1-5.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine at least one condition associated with network coverage; and
determine whether to disable or enable a neighbor cell measurement triggering based on the at least one condition when the UE is in a connected mode.

2. The UE of claim 1, wherein the at least one condition is associated with receipt of an indication received from a base station (BS), and the indication includes at least one of:
an indication of disabling the neighbor cell measurement triggering;
a system information block (SIB) dedicated for the network coverage;
satellite assistance information for the network coverage;
mean ephemeris data for the network coverage; or
a release message for a configuration of a reference signal receiving power (RSRP) threshold and/or a RSRP variation threshold for the neighbor cell measurement triggering.

3. The UE of claim 1, wherein the at least one condition includes at least one of multiple parameters configured by a network, the multiple parameters including:
a prediction of the network coverage;
a time point associated with the prediction of the network coverage;
an area associated with the prediction of the network coverage;
a location associated with the prediction of the network coverage;
a threshold of propagation delay associated with the prediction of the network coverage; or
a threshold of timing advance associated with the prediction of the network coverage.

4. The UE of claim 1, wherein the at least one condition includes at least one of multiple parameters generated by the UE, the multiple parameters including:
a prediction of the network coverage;
a time point associated with the prediction of the network coverage;
an area associated with the prediction of the network coverage;
a location associated with the prediction of the network coverage;
a threshold of propagation delay associated with the prediction of the network coverage; or
a threshold of timing advance associated with the prediction of the network coverage.

5. The UE of claim 1, wherein to disable a neighbor cell measurement triggering includes at least one of:
disabling a reference signal receiving power (RSRP) measurement of a serving cell;
stopping evaluating a RSRP and/or RSRP variation criteria for the neighbor cell measurement triggering; or
forbidding the neighbor cell measurement triggering in response to the RSRP and RSRP variation criteria being fulfilled.

6. The UE of claim 1, wherein in response to the neighbor cell measurement triggering being disabled, the at least one processor is further configured to cause the UE to perform at least one of:
discarding or storing a reference signal receiving power (RSRP) threshold and/or a RSRP variation threshold configured by a network;
stopping a timer for evaluating a RSRP variation criterion,
discarding or storing a reference RSRP value for evaluating the RSRP variation criterion;
transmitting a message indicating the neighbor cell measurement triggering is disabled;
transmitting a message indicating fulfillment of the at least one condition associated with disabling the neighbor cell measurement triggering; or
triggering a radio link failure (RLF) or a radio resource control (RRC) release.

7. The UE of claim 1, wherein in response to the neighbor cell measurement triggering being enabled, wherein the at least one processor is further configured to cause the UE to perform at least one of:
requesting a new reference signal receiving power (RSRP) threshold and/or a new RSRP variation threshold;
using a stored RSRP threshold and a stored RSRP variation threshold as the new RSRP threshold and the new RSRP variation threshold;
starting a timer for evaluating a RSRP variation criterion;
determining a measured RSRP value or a stored reference RSRP value as a reference RSRP value for evaluating the RSRP variation criterion;
transmitting a message indicating that the neighbor cell measurement triggering is enabled;
transmitting a message indicating fulfillment of the at least one condition associated with enabling the neighbor cell measurement triggering; or
prioritizing a carrier for the neighbor cell measurement indicated by a network.

8. A Base Station (BS) for wireless communication, comprising:
at least one memory; and
at least one processor coupled with the at least one memory and configured to cause the BS to:
determine at least one condition associated with network coverage; and
transmit the at least one condition to a user equipment (UE) for determining whether a neighbor cell measurement triggering will be disabled or enabled when the UE is in a connected mode.

9. The BS of claim 8, wherein the at least one condition is associated with a message transmitted to the UE, wherein the message includes at least one of:
an indication of disabling the neighbor cell measurement triggering;
a system information block (SIB) dedicated for the network coverage;
satellite assistance information for the network coverage;
mean ephemeris data for the network coverage; or
a release message for a configuration of a reference signal receiving power (RSRP) threshold and/or a RSRP variation threshold for the neighbor cell measurement triggering.

10. The BS of claim 8, wherein the at least one condition includes at least one of multiple parameters determined by the BS, the multiple parameters including:
a prediction of the network coverage;
a time point associated with the prediction of the network coverage;
an area associated with the prediction of the network coverage;
a location associated with the prediction of the network coverage;
a threshold of propagation delay associated with the prediction of the network coverage; or
a threshold of timing advance associated with the prediction of the network coverage.

11. The BS of claim 8, wherein the at least one condition is associated with at least one of:
an indication of disabling or enabling a reference signal receiving power (RSRP) measurement of a serving cell;
an indication of stopping or starting evaluating a RSRP and RSRP variation criteria for the neighbor cell measurement triggering;
an indication of forbidding or allowing the neighbor cell measurement triggering in response to the RSRP and RSRP variation criteria being fulfilled.

12. The BS of claim 8, wherein the at least one processor is further configured to cause the BS to:
receive a message indicating the neighbor cell measurement triggering is disabled;
receive a message indicating fulfillment of the at least one condition associated with disabling the neighbor cell measurement triggering; or
receive a radio link failure (RLF) report or a radio resource control (RRC) release request.

13. The BS of claim 8, wherein the at least one processor is further configured to cause the BS to:
receive a request for a new reference signal receiving power (RSRP) threshold and/or a new RSRP variation threshold;
receive a message indicating that the neighbor cell measurement triggering is enabled; or
receive a message indicating fulfillment of the at least one condition associated with enabling the neighbor cell measurement triggering.

14. The BS of claim 13, wherein in response to the neighbor cell measurement triggering is enabled for the UE, the processor is further configured to transmit an indication indicating the UE to prioritize a carrier for the neighbor cell measurement.

15. A method performed by a user equipment (UE), the method comprising:
determining at least one condition associated with network coverage; and
determining whether to disable or enable a neighbor cell measurement triggering based on the at least one condition when the UE is in a connected mode.

16. The method of claim 15, the method further comprising, in response to the neighbor cell measurement triggering being enabled:
requesting a new reference signal receiving power (RSRP) threshold and/or a new RSRP variation threshold;
using a stored RSRP threshold and a stored RSRP variation threshold as the new RSRP threshold and the new RSRP variation threshold;
starting a timer for evaluating a RSRP variation criterion;
determining a measured RSRP value or a stored reference RSRP value as a reference RSRP value for evaluating the RSRP variation criterion;
transmitting a message indicating that the neighbor cell measurement triggering is enabled;
transmitting a message indicating fulfillment of the at least one condition associated with enabling the neighbor cell measurement triggering; or
prioritizing a carrier for the neighbor cell measurement indicated by a network.

17. A processor for wireless communication, comprising:
at least one controller coupled with at least one memory and configured to cause the processor to:
determine at least one condition associated with network coverage; and
determine whether to disable or enable a neighbor cell measurement triggering based on the at least one condition when the processor is in a connected mode.

18. The processor of claim 17, wherein the at least one condition is associated with receipt of an indication received from a base station (BS), and the indication includes at least one of:
an indication of disabling the neighbor cell measurement triggering;
a system information block (SIB) dedicated for the network coverage;
satellite assistance information for the network coverage;
mean ephemeris data for the network coverage; or
a release message for a configuration of a reference signal receiving power (RSRP) threshold and/or a RSRP variation threshold for the neighbor cell measurement triggering.

19. The processor of claim 17, wherein the at least one condition includes at least one of multiple parameters configured by a network, the multiple parameters including:
a prediction of the network coverage;
a time point associated with the prediction of the network coverage;
an area associated with the prediction of the network coverage;
a location associated with the prediction of the network coverage;
a threshold of propagation delay associated with the prediction of the network coverage; or
a threshold of timing advance associated with the prediction of the network coverage.

20. The processor of claim 17, wherein the at least one condition includes at least one of multiple parameters generated by the processor, the multiple parameters including:
a prediction of the network coverage;
a time point associated with the prediction of the network coverage;
an area associated with the prediction of the network coverage;
a location associated with the prediction of the network coverage;
a threshold of propagation delay associated with the prediction of the network coverage; or
a threshold of timing advance associated with the prediction of the network coverage.
